(19) United States
(12) Patent Application Publication
(10) Pub. No.: US 2016/0298801 A1
(43) Pub. Date: Oct. 13, 2016

(54) TUBE FASTENER ASSEMBLY AND METHOD FOR FASTENING A TUBE TO A TUBE FASTENER ASSEMBLY

(71) Applicant: EATON INDUSTRIAL IP GMBH & CO. KG, Schönefeld (DE)

(72) Inventors: Christian HUCK, Roeschwoog (FR); Andre BERTRAND, Drusenheim (DE)

(21) Appl. No.: 15/037,727

(22) PCT Filed: Nov. 20, 2014
(86) PCT No.: PCT/EP2014/075196

§ 371 Date: May 19, 2016

(30) Foreign Application Priority Data
Nov. 20, 2013 (GB) 1320526.5

(51) Int. Cl. F16L 41/08; F16L 41/00

(52) U.S. Cl. CPC F16L 41/086; F16L 41/007

(57) ABSTRACT

A tube fastener assembly has a retention element having a fastener portion and a holding portion, a connection element having a fluid channel for a flow of fluid between a connection end of the fluid channel and a tube end of the fluid channel, wherein the connection element is adapted for being fixed to the holding portion of the retention element, wherein the connection element is rotatable about an axis of rotation relative to the retention element before being fixed to the holding portion of the retention element.

### CROSS-REFERENCE TO RELATED APPLICATIONS

This application is a U.S. national stage application under 35 U.S.C. §371 of International Application No. PCT/EP2014/075196, filed on Nov. 20, 2014, and claims benefit to British Patent Application No. 1 320 526.5, filed on Nov. 20, 2013. The International Application was published in English on May 28, 2015, as WO 2015/075144 Al under PCT Article 21(2).

### FIELD

The present invention relates to a tube fastener assembly and a method for fastening a tube to a tube fastener assembly in particular for a coolant passage in a refrigerating cycle for vehicles.

### BACKGROUND

In refrigeration cycles the different components such as a compressor, a condenser, an expansion valve and an evaporator, have to be connected through refrigerant pipes and tubes in order to form a refrigerant circuit. In particular, in the use of such a refrigerant cycle in a vehicle the refrigerant cycle is exposed to vibrations so that the joints between the components and the pipes and tubes need to have a sufficient strength.

However, the implementation of tube fastener assemblies according to the invention is not limited to refrigeration cycles but can also be used in other joining pipes and tubes.

U.S. Pat. No. 8,141,911 B2 discloses several embodiments of tube fastener assemblies according to the prior art. In one embodiment a pipe connection joint includes a flange and a pipe connection portion. A pipe is welded on a side of the flange in such a way as to communicate with the pipe connection portion. When the flange is joint to a connection object through a bolt, the pipe connection portion of the flange is connected to a passage of the connection object. The pipe extends from the flange in a direction transverse to the direction of the pipe connection portion. According to the required angle at which the pipe extends from the flange different pipes or flanges have to be provided. Hence, the mounting direction of the pipe on the flange cannot be changed so that various kinds of flanges must be manufactured in correspondence with various mounting directions of the pipe.

U.S. Pat. No. 8,141,911 B2 describes further embodiment according to which the flange includes a pipe joining hole penetratingly formed therein in correspondence with a passage of the connection object. A pipe is formed in an L-shape and is provided with an extended portion at a connection portion of the pipe. The pipe is inserted into the pipe joining hole of the flange wherein the extended portion of the pipe is held in a widened portion of the pipe joining hole so that the pipe is supported within the pipe joining hole. In this mounted state the connection portion of the pipe projects over a lower face of the flange. When mounting the flange to a connection object the connection portion of the pipe is inserted into a passage of the connection object. Before fastening the flange to the connection object the L-shaped pipe can be rotated within the pipe joining hole in order to adjust the mounting direction of the pipe. When fixing the flange to the connection object the pipe is pressed into stepped portions of the widened portion of the pipe connection hole, preventing a rotation of the pipe after fixation. The connection between the pipe and the flange is made during the connection of the flange to the connection object. It is not possible to pre-assemble the pipe and the flange prior mounting the flange to the connection object. Further, a bending process of the pipe is necessary because the pipe itself is fluidly connected to the passage of the connection object.

WO 01/63168 A1 discloses another embodiment of a tube fastener assembly having a flange which can be fixed to a connection object. The flange is provided with a pipe joining hole. A pipe being inserted into the pipe joining hole and being inserted into a passage of the connection object. The pipe is L-shaped and is guided through an aperture of a bracket. The bracket is fixed to the flange and can be orientated in a number of discrete angles mounting positions in order to vary the mounting direction of the pipe. For connecting the bracket to the flange both elements are provided with a toothing.

### SUMMARY

An aspect of the invention provides a tube fastener assembly, comprising: a retention element including a fastener portion and a holding portion; and a connection element including a fluid channel configured to allow a flow of fluid between a connection end of the fluid channel and a tube end of the fluid channel. The connection element is configured to be fixed to the holding portion of the retention element. The connection element is rotatable about an axis of rotation relative to the retention element before being fixed to the holding portion of the retention element.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a perspective view of an embodiment of a tube fastener assembly according to the present invention;

FIG. 2 is a longitudinal sectional view of the tube fastener assembly according to FIG. 1;

FIG. 3 is a sectional view of an exemplary connection object; and

FIG. 4 is another sectional view of the tube fastener assembly according to FIG. 1.

### DETAILED DESCRIPTION

An aspect of the invention provides a tube fastening assembly which enables an easy assembly of the tube fastening assembly with the possibility to adjust a mounting direction of a pipe as required.

An aspect of the invention provides a tube fastener assembly comprising a retention element having a fastener portion and a holding portion, a connection element having a fluid channel for a flow of fluid between a connection end of the fluid channel and a tube end of the fluid channel, said connection element is adapted for being fixed to the holding portion of said retention element, wherein the connection element is rotatable about an axis of rotation relative to said retention element before being fixed to the holding portion of said retention element.

An advantage is that the tube fastener assembly can be pre-assembled in any desired mounting direction of the tube. In addition, the connection element is fluidly connected to a passage of a connecting object providing a high connection strength between the connection element and the connection object to which the tube fastening assembly is mounted.

Preferably, the connection element is adapted for being bonded, in particular brazed, soldered, welded or glued, to the holding portion of the retention element.

The fastener portion of the retention element is positioned off-set to the axis of rotation so that the tube fastener assembly is secured against rotation when being mounted to a connection object.

A tube is mounted to the tube end of the fluid channel, wherein the tube can be bonded, in particular brazed, soldered, welded or glued. The bonding of the tube can be made within one process of bonding the bonding of the connection element to the retention element.

Preferably, the tube end is positioned off-set to the axis of rotation.

Further, the fastener portion of the retention element is provided with a bore for retaining a screw to mount the tube fastener assembly to the connection element, such as a component of a refrigerant circuit.

The bore is typically orientated parallel to the axis of rotation.

The retention element preferably has a contact surface for mounting the retention element to a mounting surface of a connection object such as an aggregate or component of a refrigerant circuit.

The holding portion of the retention element is adapted to hold the connection element between the holding portion and the mounting surface of the connection object. Thereby, the joining strength between the connection element and the connection object is enhanced.

The holding portion of the retention element may have a collar being in contact to a collar of the connection element wherein the collar of the connection element is bonded to the collar of the retention element.

This can be accomplished by a collar of the connection element which is adapted for being held between a collar of the retention element and the mounting surface of the connection object.

Preferably, the connection element is continuously rotatable relative to the retention element before being fixed.

An embodiment of the present invention provides a method for fastening a tube to a tube fastener assembly comprising the steps of providing a tube fastener assembly having a retention element with a holding portion and a connection element with a fluid channel for a flow of fluid between a connection end of the fluid channel and a tube end of the fluid channel, wherein the connection element is rotatable about an axis of rotation relative to said retention element, rotating said connection element relative to the retention element to a desired position, fixing said connection element to said holding portion of said retention element.

Preferably, the connection element is fixed to said holding portion of the retention element by the bonding process such like brazing, soldering, welding or gluing.

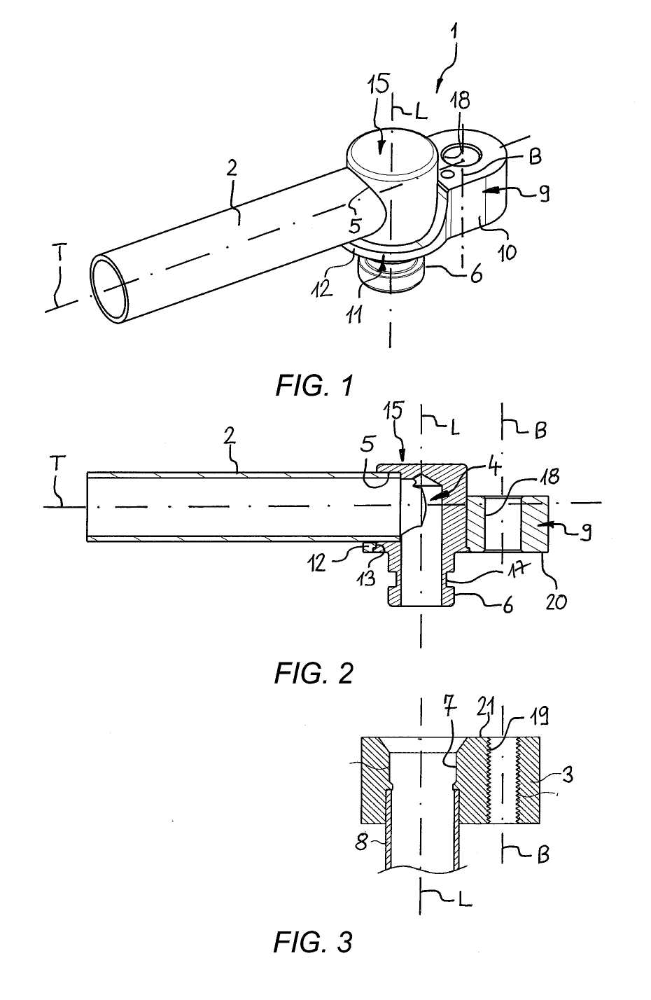

FIG. 1 is a perspective view of a tube fastener assembly 1 connected to a tube 2 and FIG. 2 is a longitudinal sectional view of the tube fastener assembly 1 with tube 2 according to FIG. 1. The tube fastener assembly 1 can be mounted and connected to a connection object 3 which is depicted in FIG. 3. FIGS. 1 to 3 are described together.

The tube fastener assembly 1 has a fluid channel 4 for a flow of fluid. The fluid channel 4 has a tube end in the form of the fixation bore 5. The tube 2 is inserted into the fixation bore 5 and sealingly connected to the tube fastener assembly 1 for example by a bonding process such as brazing, soldering, welding or gluing. At the other end the fluid channel 4 has a connection end provided in the form of a projection 6. The projection 6 can be inserted into a passage 7 of the connection object 3 in a sealingly manner. For this reason the projection 6 is provided with a circumferential groove 17 for holding a sealing ring (not shown) which is in sealing contact with the projection 6 and the passage 7.

Thus, the tube fastener assembly 1 provides a flow passage from the tube 2, which is connected to the tube fastener assembly 1, and a tube 8 which is fixed to the connection object 3. The projection 6 as well as the whole tube fastener assembly 1 is produced by a cutting process and has a high stability providing for an enhanced joining strength between the tube fastener assembly 1, particularly the projection 6, and the connection object 3.

For fixing the tube fastener assembly 1 the tube fastener assembly 1 is provided with a bore 18 which is aligned with a threaded bore 19 in the connection object 3. A screw can be inserted through the bore 18 and can be screwed into the threaded bore 19 in order to fix the tube fastener assembly 1 to the connection object 3. The bore 18 and the threaded bore 19 are positioned off-set and parallel to the projection 6 of the tube fastener assembly 1 and the passage 7 of the connection object 3. Thus, when the projection 6 is inserted into the passage 7 the screw inserted through the bore 18 and screwed into the threaded bore 19 secures the tube fastener assembly 1 from being rotated about the longitudinal axis L of the projection 6.

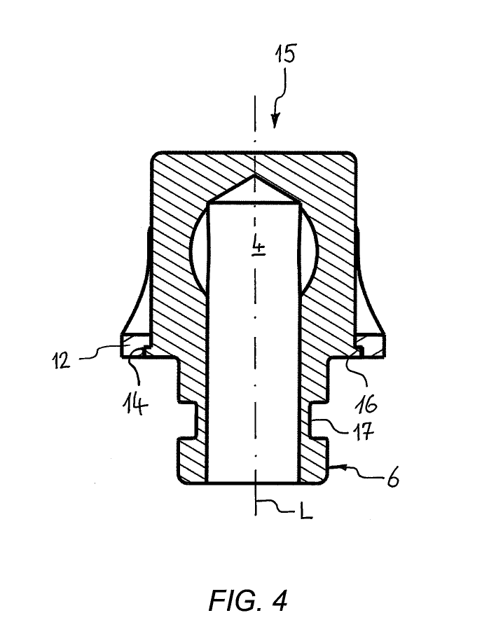

The tube fastener assembly 1 comprises a retention element 9 and a connection element 15 which are fixed to each other and which can be rotated about the longitudinal axis L (axis of rotation) before being fixed. The retention element 9 has a fastener portion 10 and a holding portion 11. The fastener portion 10 is provided with a bore 18 for retaining the above-mentioned screw. The holding portion 11 has a ring-shaped collar 12 forming a holding bore 13. The connection element 15 is inserted into the holding bore 13 of the holding portion 11. As can be best seen in FIG. 4 the connection element 15 is provided with a circumferential outer collar 14 which is in contact with the collar 12 of the holding portion 11. The collar 14 of the connection element 15 is supported against a step 16 within the ring-shaped collar 12 of the holding portion 11. The collars 12, 14 are formed such that they establish a common contact surface 20 which is in contact with a mounting surface 21 of the connection object 3 in an assembled condition.

In the disclosed embodiment a tube axis T of the tube 2 being connected to the connection element 15 intersects the longitudinal axis L of the connection element 15 at a right angle. However, this angle can deviate from a right angle. Further, the connection element 15 is fixed to the retention element 9 such that the mounting direction of tube 2 is straight in regard to the bore 18 of the holding portion 11. In other words, a first plain containing the tube axis T and the longitudinal axis L is identical to a second plain containing the longitudinal axis L and a bore axis B of bore 18. However, before fixing the connection element 15 to the retention element 9 the connection element 15 can be freely rotated. In the disclosed embodiment as shown in FIG. 1 the connection element 15 can be rotated by approximately 90 degrees clockwise and 90 degrees counter clockwise. After the required mounting direction has been reached the connection element 15 can be fixed by a bonding process to the retention element 9.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### REFERENCE NUMERALS LIST

1 tube fastener assembly
2 tube
3 connection object
4 fluid channel
5 tube end/fixation bore
6 connection end/projection
7 passage
8 tube
9 retention element
10 fastener portion
11 holding portion
12 collar of the holding portion
13 holding bore
14 collar of the connection element
15 connection element
16 step
17 groove
18 bore
19 threaded bore
20 contact surface
21 mounting surface
L longitudinal axis
T tube axis
B bore axis

1: A tube fastener assembly, comprising:
a retention element including a fastener portion and a holding portion; and
a connection element including a fluid channel configured to allow a flow of fluid between a connection end of the fluid channel and a tube end of the fluid channel,
wherein the connection element is configured to be fixed to the holding portion of the retention element,
wherein the connection element is rotatable about an axis of rotation relative to the retention element before being fixed to the holding portion of the retention element.

2: The assembly of claim wherein the connection element is configured to be bonded to the holding portion of the retention element.

3: The assembly of claim 2, wherein the connection element is configured to be brazed, soldered, welded, or glued to the retention element.

4: The assembly of claim 1, wherein the fastener portion of the retention element is positioned off-set to the axis of rotation.

5: The assembly of claim 1, further comprising:
a tube, mounted to the tube end of the fluid channel.

6: The assembly of claim 1, wherein the tube end is positioned offset to the axis of rotation.

7: The assembly of claim 1, wherein the fastener portion of the retention element includes a bore configured to retain a screw.

8: The assembly of claim 7, wherein the bore is orientated parallel to the axis of rotation.

9: The assembly of claim 1, wherein the retention element includes a contact surface configured to mount the retention element to a mounting surface of a connection object.

10: The assembly of claim 9, wherein the holding portion of the retention element is configured to hold the connection element between the holding portion and the mounting surface of the connection object.

11: The assembly of claim 10, wherein the holding portion of the retention element includes a first collar in contact to a second collar of the connection element, and
wherein the second collar of the connection element is bonded to the first collar of the retention element.

12: The assembly of claim 11, wherein the second collar, of the connection element, is configured to be held between the first collar, of the retention element, and the mounting surface of the connection object.

13: The assembly of claim 1, wherein the connection element is continuously rotatable relative to the retention element.

14: A method for fastening a tube to a tube fastener assembly, the method comprising:
providing a tube fastener assembly having a retention element and a connection element the retention element including the holding portion and the connection element including a fluid channel configured to allow a flow of fluid between a connection end of the fluid channel and a tube end of the fluid channel, the connection element being rotatable about an axis of rotation relative to the retention element;
rotating the connection element relative to the retention element to a desired position; and
fixing the connection element to the holding portion of the retention element.

15: The method of claim 14, wherein the fixing of the connection element to the holding portion of the retention element includes to bonding process.

16: A method for fastening a tube to a tube fastener assembly, the method comprising:
in the assembly of claim 1, rotating the connection element relative to the retention element to a desired position; and
fixing the connection element to the holding portion of the retention element.
